(19) United States
(12) Patent Application Publication
(10) Pub. No.: US 2011/0305160 A1
(43) Pub. Date: Dec. 15, 2011

(54) SYSTEM, DEVICE, AND TERMINAL FOR RESOLVING AN OBFUSCATED NETWORK ADDRESS OF A NETWORK DEVICE WITHIN A NETWORK

(75) Inventors: Paul Green, Annapolis, MD (US); Michael Rash, Mount Airy, MD (US); Judy Novack, Marriottsville, MD (US)

(73) Assignee: G2, INC., Annapolis Junction, MD (US)

(21) Appl. No.: 13/159,646

(22) Filed: Jun. 14, 2011

Related U.S. Application Data
(60) Provisional application No. 61/354,463, filed on Jun. 14, 2010.

(51) Int. Cl. H04L 12/26

(52) U.S. Cl. 370/252

(57) ABSTRACT

A system for identifying a network device includes a local area network (“LAN”), an external network, one or more network devices, a packet-modifying device, a monitoring device, a data store, and an analysis terminal. Each network device is configured for having a network address and to communicate with the LAN. The packet-modifying device is coupled to the LAN and the external network and has an external-network network address. The monitoring device generates identifying information of the network device when communicating with the external network via the packet-modifying device. The monitoring device configures the identifying information to identify the obfuscated network address of the network device. The data store stores the identifying information. The analysis terminal is coupled to the data store and is adapted to resolve the network address of the network device upon receiving an alert regarding the network address obfuscated by the packet-modifying device.

### CROSS-REFERENCE TO RELATED APPLICATION

This application claims priority to and benefit of U.S. Provisional Application Ser. No. 61/354,463 to Paul Green et al., entitled “SYSTEM AND METHOD FOR RESOLVING AN OBFUSCATED NETWORK ADDRESS OF AN INTERNET PROTOCOL DEVICE WITHIN A NETWORK,” filed on Jun. 14, 2010 in the United States Patent and Trademark Office, the entire contents of which are incorporated herein by reference.

### BACKGROUND

1. Technical Field

The present disclosure relates to determining network addresses. More particularly, the present disclosure relates to a system, device, and terminal for resolving an obfuscated network address (e.g., an MAC address, IP address, or other type of network address) of a network device, such as a personal computer, within a network.

2. Description of Related Art

Many networks utilize formatted units of data (“packets”) for communicating data between computers and network devices. The networks that utilize packets for communicating are commonly referred to as packet-mode computer networks. These packets of data are formatted into blocks of data that define workable units for use throughout the network. Files too large for insertion into a single packet are broken up into smaller packets and a sequence number may be assigned (in some protocols) to each respective packet so that the receiving device may reassemble the data contained within the packets in the correct order alter all packets are received. However, please note that not all protocols assign sequence numbers to packets. Also in some protocols such as TCP, the receiving device may request that any missing packets be resent. The packets include predefined data locations where routing and other information are located for utilization by devices within the network to facilitate routing of the packets. Any device acting upon a packet uses data within the predefined data locations to route the packet through the network and to facilitate error-free data communications.

The internet is a packet-mode computer network that utilizes IP packets. IP packets usually include payload data having additional layers. That is, IP packets generally comprise the underlying data to be communicated, surrounded by one or more layers of header and footer information to enable the forwarding of the packet from IP device to IP device via a routing protocol that enables IP communications. Initially, a header identifying the application is appended to the data, i.e. the application layer of the header. Thereafter, a header identifying the ports and communication protocol is appended, i.e. the transport layer of the header. The network layer identifies the source and destination devices by their network addresses, such as an IP address. The immediate link protocol information may be included in the data link layer.

For internet applications, the network layer comprises the IP address of the source and destination IP devices. Proper transmission requires that these addresses be unique. However, their number is limited. For example, there are at most 2̂32 IP addresses for IPv4 and 2̂128 IP addresses for IPv6. An end user may, for example, lease an internet connection and be assigned only a single IP address. To reduce the demand on IP addresses and prevent their overuse, IP devices connected through a gateway, such as a router, to the Internet are not necessarily given Internet unique IP addresses. For example, devices within a local area network (“LAN”) with access to the Internet through a router will have IP addresses which are unique relative to all devices within the LAN, but are not unique relative all devices on the Internet. In general, RFC1918 addresses are heavily used because of the IPv4 exhaustion coupled with advantages in terms of security.

Furthermore in this example, for intranet communications, each LAN device has a LAN unique IP address that is not unique to the internet. Therefore, the LAN devices have no difficulty identifying each other and communicating between each other. Since its network address is not unique with respect to other devices on the Internet, its packets cannot be forwarded directly to their respective destinations. Rather, a LAN device that wants to forward a packet to a destination device on the Internet initially includes its LAN IP address in the network layer header and forwards the packet to the router. The router removes the LAN IP address and inserts its own Internet unique IP address before being sent to the intended destination. The router records the LAN IP address, the destination IP address, the source port, the destination port, and the protocol type from the network and transport layers of the packet and then forwards the packet to its destination over the internet. This process is generally referred to as Network Address Translation (“NAT”). A device that performs this process is referred to as a NAT or a NAT device.

Network Address Translation is based on the concept of address reuse by private networks, e.g., LANs, and operates by mapping the reusable IP addresses of the leaf domain to the globally unique ones required for communication with hosts on the Internet. In implementation, a local host wishing to access the Internet receives a temporary IP address from a pool of such addresses available to the network assigned the single (or limited number of) IP addresses. While the host is sending and receiving packets through the Internet, it has a global IP address that is unavailable to any other host. After the host disconnects from the Internet, the enterprise takes back its global IP address and makes it available to other hosts wishing to access outside networks.

A device implementing NAT (e.g., a router) must be provided between the private network and the Internet. By virtue of this location, the router is also sometimes grouped with other packet-modifying devices. A NAT device is a type of packet-modifying device. For example, NAT devices are also sometimes grouped with other packet-modifying devices such as a firewall or proxy to protect the local private network from unwanted Internet packets.

While the usage of NAT helps to delay the onset of the IP address exhaustion problem, there are other problems introduced by NAT. For systems that are external to the NAT and would like to communicate with systems that are internal to the NAT, normal direct routing via standard routing protocols is insufficient. The NAT device itself must maintain a mapping between the internal address space with the systems internal to the NAT and the external network e.g., the Internet. If this mapping is not maintained, then reliable communications (either outbound or the corresponding return traffic) ceases. Given the importance of NAT to IPv4 communications, new technologies to further integrate with NAT will become more important over time.

### SUMMARY

The present disclosure relates to determining network addresses, and in particular, to a system, device, and terminal for resolving an obfuscated network address of a network device (e.g., an IP device), such as a personal computer, within a network.

In one embodiment of the present disclosure, a system for identifying a network device includes a local area network (“LAN”), an external network, one or more network devices, a packet-modifying device, a monitoring device, a data store, and an analysis terminal. The one or more network devices are coupled to the LAN. Each network device is configured for having a network address and is further configured to communicate with the LAN. The packet-modifying device is coupled to the LAN and the external network and has an external-network network address. The packet-modifying device is coupled to the one or more network devices and upon receipt of a communication from a network device of the one or more network devices destined for the external network obfuscates the network address of the network device prior to transmission of the communication to the external network. The monitoring device is operatively coupled to the one or more network devices for monitoring the one or more network devices. The monitoring device generates identifying information of the network device when communicating with the external network via the packet-modifying device. The monitoring device configures the identifying information to identify the obfuscated network address of the network device. The data store stores the identifying information. The analysis terminal is coupled to the data store and is adapted to resolve the network address of the network device upon receiving an alert regarding the network address obfuscated by the packet-modifying device.

In another embodiment of the present disclosure, a monitoring device includes one or more network interfaces and a processing component. The one or more network interfaces are configured for coupling to a LAN. The processing component is operatively coupled to the one or more network interfaces to monitor communications between a network device within the LAN and an external network. The monitoring device generates identifying information of the network device using the communications, and the identifying information is configured for identifying an obfuscated network address of the network device.

In yet another embodiment of the present disclosure, an analysis terminal includes a network interface and a processing component. The network interface is configured for coupling to a monitoring device. The processing component is operatively coupled to the network interface to query the monitoring device for identifying information. The indentifying information is configured to identify a network device using communications between the network device within a LAN and an external network. The query is configured to query the monitoring device for identifying the network device using an obfuscated network address of the network device in accordance with an alert including the obfuscated network address.

### BRIEF DESCRIPTION OF THE DRAWINGS

These and other advantages will become more apparent from the following detailed description of the various embodiments of the present disclosure with reference to the drawings wherein:

FIG. 1 is an illustration of an IP packet according to the present disclosure;

FIG. 2 is an illustration of a Transmission Control Protocol (“TCP”) packet according to the present disclosure;

FIG. 3 is diagram of a system for resolving an obfuscated network address of an IP device within a network according to the present disclosure;

FIGS. 4A and 4B show an illustration of the operation of the monitoring device of FIG. 3 when a packet-modifying device alters the LAN IP address according to the present disclosure:

FIGS. 5A and 5B show an illustration of the operation of the monitoring device of FIG. 3 when a packet-modifying device alters the LAN IP address and a port value according to the present disclosure;

FIGS. 6A and 6B show an illustration of the operation of the monitoring device of FIG. 3 when a packet-modifying device alters the LAN IP address, a port value, and part of the protocol header according to the present disclosure;

FIGS. 7A and 7B show an illustration of the operation of the monitoring device of FIG. 3 when a packet-modifying device alters the LAN IP address, the port value, and all of the protocol header according to the present disclosure;

FIGS. 8A and 8B show an illustration of the operation of the monitoring device of FIG. 3 when a packet-modifying device alters the entire IP header and all of the protocol header according to the present disclosure; and

FIGS. 9A and 9B show an illustration of the operation of a monitoring device of FIG. 3 when multiple packet-modifying devices alter the LAN communications according to the present disclosure.

### DETAILED DESCRIPTION

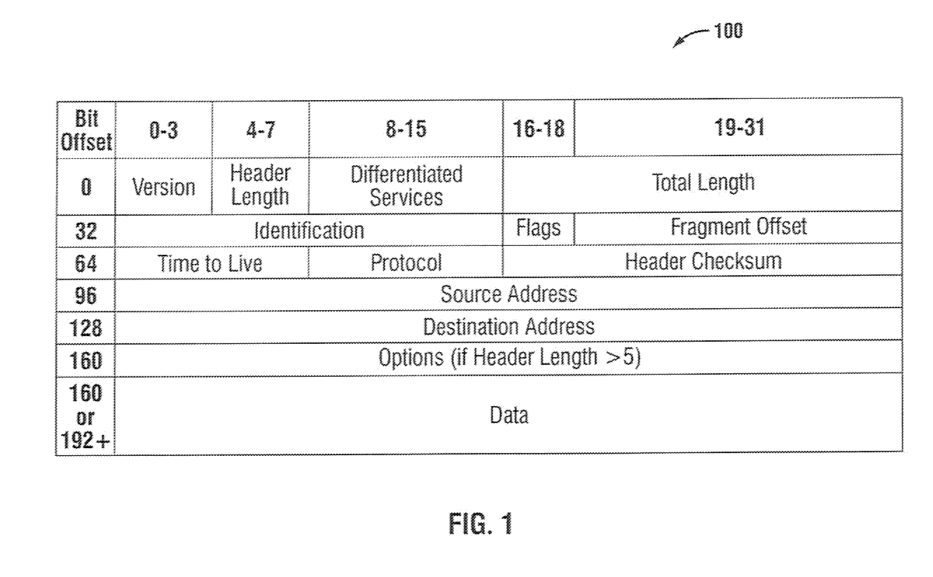

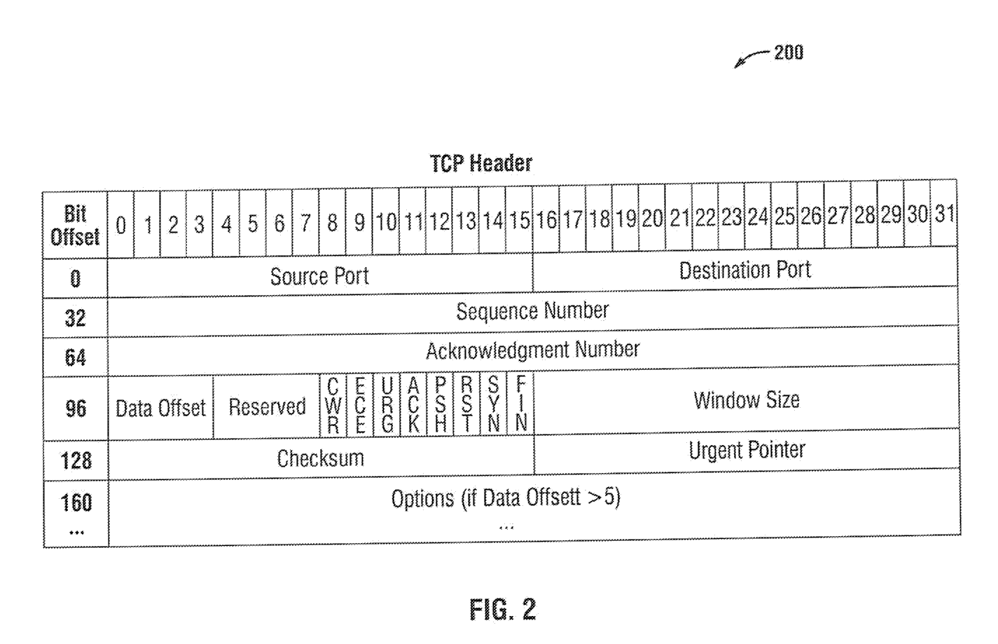

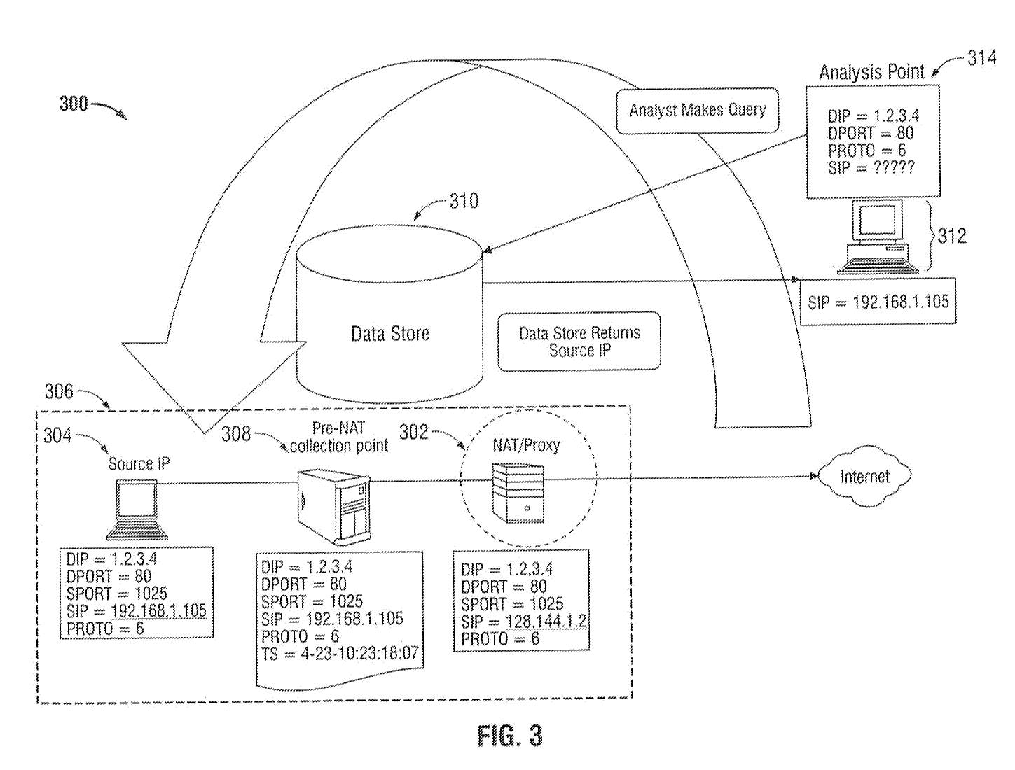

FIG. 1 shows an illustration of an IP packet 100, and FIG. 2 shows an illustration of a TCP packet 200 according to the present disclosure. Packet 200 of FIG. 2 may be encapsulated within Packet 100 of FIG. 1. FIG. 3 shows a system 300 for determining the network address of an internet protocol device within a network. System 300 includes a packet-modifying device or NAT 302, a computer 304 (a type of network device), a LAN 306, a monitoring device 308, a data store 310, and an analysis terminal or analysis point 312. LAN 306 includes monitoring computer 304, device 308 and packet-modifying device 302. System 300 may be compatible with all forms of NAT technology, may minimize new network communications, may be compatible with any sensing data format that logs packet headers, and may minimize new hardware deployments.

The packet-modifying device 302 as shown in FIG. 3 is a NAT device and a proxy server. The packet-modifying device 302 includes an internet accessible IP address and can route packets between the internet and one or more internet protocol (“IP”) devices within the LAN 306 such as the personal computer 304 or network devices (not shown) by acting as a NAT. For example, the computer 304 may be assigned a LAN IP address by the NAT functionality of the packet-modifying device 304 which is then used by the packet-modifying device 302 to translate communications between the computer 304 and hosts on the internet.

When performing its NAT function, packets leaving the computer 304 and destined for an internet address IP destination passes through the packet-modifying device 302. The packet-modifying device 302 modifies the source address of the IP packet as shown in Fig. I by replacing it with the internet addressable IP address of the packet-modifying device 304. An internet device (not shown) responding to computers 304's request can respond using the Internet addressable IP address of the packet-modifying device 302. In other embodiment of the present disclosure, the packet-modifying device 302 may be a MAC address translator.

The packet-modifying device 302 maintains a table to route incoming IP packets correctly. The packet-modifying device 302 uses the table to route incoming packet destined to the internet accessible IP address of the modifying device 302 to a respective internet protocol device within the LAN 306, e.g., computer 304. Additionally, packet-modifying device 302 may modify the source port of a TCP packet, e.g., the TCP 200 packet as shown in FIG. 2, to facilitate communications through the packet-modifying device 302 that occurs between multiple internet protocol devices within the LAN 306 and the internet. The packet-modifying device 302 generates a NAT table to correlate responses originating from internet locations for mapping packets back to the originating LAN device address using “rules or “states” stored in the translation tables. For example, the packet-modifying device 302 may generate a table regarding outbound traffic from the computer 304 so that when the destination server responds to the computer 304's requests, the response will be routed to the computer 304 despite that the response is addressed to the internet addressable IP address of the packet-modifying device 302.

The NAT functionality of the packet-modifying device 302 obfuscates the LAN IP addresses within the LAN 306. This obfuscation facilitates security, but it is also a hindrance when trying to resolve security issues rooted within a device of the LAN 306. When the NAT functionally of the packet-modifying device 302 is used, additional facilitates are needed to identify IP devices within the LAN 306 because the traffic from an IP device within the LAN 306, e.g., the computer 304, has an altered IP address after passing through the packet-modifying device 302. This impedes any attempt to identify a compromised IP device within the LAN 306 based on network traffic analysis conducted outside of the LAN 306 because of the address translation functionality (i.e., the NAT function) of the packet-modifying device 302. Therefore, the monitoring device 308, the data store 310, and/or the analysis point 312 may be utilized to facilitate determining the source of one or more security issues within the LAN 306 when the security issue is identified using traffic communications intercepted outside of the LAN 306. One or more sensors may be positioned anywhere within the LAN 306 or positioned to monitoring communications from the packet-modifying device and the internet to record information, e.g., packets, for the monitoring device 308 or the data store 310. Additionally or alternatively, these sensors may be a monitoring device 308.

The system 300 may include some sensing infrastructure, such as a sensor outside of the LAN 306, that be deployed outside of the packet-modifying device 302 to provide data (usually either in the form of IDS events, raw flow data, or full packet capture “pcap” data) that is interesting to the network defender (e.g., an analyst using the analysis point 312) but may require additional analysis. The system 300 helps the analysis stage by allowing the analyst using the analysis point 312 to resolve pre-NAT IP addresses in the sensing data source. Typical deployments of network monitoring software that collect flow data and passive OS fingerprinting data can rely on the libpcap packet capture library and may be used by the system 300 in order to track internal IP addresses associated with inbound and outbound traffic that traverses a packet-modifying device 302 (e.g., a NAT device).

The monitoring device 308, the data store 310, and/or the analysis point 312 may be embodied in software, hardware, firmware, microcode, a virtual machine, software in execution, bytecode, in simulation, on a personal computer, and the like. For example, the monitoring device 308 may include a personal computer having specialized hardware (not explicitly shown) such as by implementing all or a portion of a method or system for resolving an obfuscated network address in a hardware description language such as VHDL programmed in a field-programmable gate array. The monitoring device 308, the data store 310, and/or the analysis point 312 may include one or more processors configured to execute a set of instructions for executing a method or system for resolving an obfuscated network address disclosed herein. In some embodiments, the disclosed method or system for resolving an obfuscated network address may be embodied in one or more software modules operatively executed on the one or more processors. The monitoring device 308, the data store 310, and/or the analysis point 312 may be implemented in software stored on a hard disk, magnetic storage, a magnetic disk, volatile memory, non-volatile memory, flash memory, an EEPROM, solid-state storage, optical storage, a magneto-optical disc storage, RAM, ROM, dynamic memory, static memory, firmware storage, and the like.

The monitoring device 308 may be isolated from devices within the LAN 306 and/or may be isolated from the packet-modifying device 302. The isolation may include: limited access, no access, or only passive access to communications therefrom. Additionally or alternatively, the monitoring device 308 may be only accessible from a single computer, such as from the analysis point 312, or may be only accessible via authorized computers outside of the LAN 306, e.g., via computers that are deemed as being authorized and/or authenticated utilizing passwords, encryption, or other authentication or authorization techniques. The monitoring device 308 may be installed passively and require no or minimal modification of the LAN 306. For example, the monitoring device 308 may be coupled to the physical wires within LAN 306 to monitor communications therewithin and/or may function as a pass-through device that does not modify packets, but rather “passes” the packets from the IP devices such as the computer 304 along to the packet-modifying device 302 or other destination. The monitoring device 308 monitors the communications between the computer 304 and the packet-modifying device 302 to match external, public traffic flows to internal, private address space within the LAN 306.

The monitoring device 308 and the data store 310 may cooperate to store unique entries regarding packet-based communications to facilitate an authorized user of the analysis point 312 to resolve an obfuscated address of an IP device within the LAN 306. The monitoring device 308 may monitor communications and store within the data store 310 the destination IP paired with a timestamp, the protocol, the destination IP address, the destination port if supported by the protocol, the source port if associated with the protocol, the source Media Access Control (“MAC”) address, if available, the Transmission Control Protocol (“TCP”) Initial Sequence Number (ISN), the packet length, the Internet Protocol Flow Information Export (“IPFIX”) total packets, other flow data format, and the IPFIX total bytes for later retrieval. The data store 310 can handle multiple queries at once. In some embodiments of the present disclosure, the monitoring device 308 monitors protocols that do not utilize ports by identifying data associated with a source IP such as the protocol type, a timestamp and the destination IP. These values are updated into data store 310. Other aspects of packet communications may be monitored by monitoring device 308 and stored by data store 310 such as the version, the header length, the differentiated services, the total length, the identification, the various flags, the fragment offset, the time to live, the protocol, the header checksum, the source address, the destination address, and the options as shown in FIG. 1 and/or, the source port, the destination port, the sequence number, the acknowledgement number, the data offset, the reserved space, various flags, the windows size, the checksum, the urgent pointer and the options as shown in FIG. 2.

Referring again to FIG. 3, the monitoring device 308 can extract values from IPFIX formatted data fields (or other flow data fields) that are available via monitoring the LAN 306. Additionally, an alert 404 may be issued using the IPFIX formatted fields or other flow data format fields. Other fields that may be monitored include the destination IP and protocol. The monitoring device 308 also collects the destination port for protocols that support them. Additionally, the monitoring device 308 can record the source IP address, a timestamp to pinpoint when a packet was sent, and a source MAC address when LAN 306 utilizes Dynamic Host Configuration Protocol (“DHCP”) and MAC address-to-physical host pairings are monitored by the monitoring device 308 and stored in the data store 310. The monitoring device 308 may also monitor LAN 306 using SYN packets of TCP sessions. Other information may also be collected as a function of the protocol being utilized.

Because the monitoring device 308, in some embodiments, records minimal source data, such as the protocol, the source IP, the destination IP, and the port, more than one LAN IP address may be identified as the potential security risk. For example, when multiple IP devices within the LAN 306 indicate that two or more hosts are communicating with the same destination IP and port and are using the same protocol about the same time. This may occur when several IP devices within the LAN 306 are infected with the same malware.

As described above, this overlap may indicate the use of a common destination IP and port such as a common search engine location. Or, the overlap may indicate that multiple hosts are infected with the same malware all of which attempts to communicate to an identical host and port at the same time. In the latter situation, it is desirable for analysis point 312 to receive all source IPs associated with the activity. An “overlap” becomes a problem only if many source Ws are returned by the data store 310 when queried by the analysis point 312, and either a single source IP or very small subset of the returned ones is associated with the alert 314 that signals some malicious activity. However, the timestamp associated with the stored record within the data store 310 facilitates an increased ability to differentiate the entries to identify the real source IP. Additional data may be collected by the monitoring device 308 to help disambiguate overlaps depending on the protocol, format of the data available for capture and analysis, and the packet permutations in transit.

The monitoring device 308 may also collect the total bytes/packets from IPFIX which represent the total number of bytes/packets exchanged in a “session.” Additionally or alternatively, the monitoring device 308 can collect the total bytes/packet for other data flow formats. This information may also be stored within data store 310. The notion of session is clearly defined for TCP facilitating easy collection of the total bytes/packets exchanged in a session. However, determining the number of bytes/packets exchanged during a User Datagram Protocol (“UDP”) “session” is less clear and aggregation may yield different values on the collection and analysis points. Additionally, the monitoring device 308 should make modification to the bytes/packets exchanged during a session to account for the situation in which the TCP header is altered by a proxy causing the number of bytes to change as the packet crosses the network. The monitoring device 308 can monitor and use the total number of bytes/packets exchanged during a session to facilitate resolving the LAN IP address that is obfuscated despite the possibility of overlaps.

The monitoring device 308 may also collect the TCP initial sequence number from an IPFIX packet or other flow data format. The initial sequence number is a 32-bit randomly generated number that represents the first TCP sequence number of a session. The TCP initial sequence number almost always identifies a packet because it is generally a unique indicator for any TCP session and it is easily identifiable and extractable from a single packet. The monitoring device 308 may use Yet Another Flowmeter (“YAF”) or the library of packet capture (“libpcap”) to determine the Initial Sequence Number (“ISN”).

The monitoring device 308 and the data store 310 communicate securely. Additionally, the analysis point 312 can communicate with the monitoring device 308 and/or the data store 310 using secure channels. In some embodiments, a tiered solution may be utilized having multiple analysis points 312 and/or multiple data stores. In a tiered solution, each tier communicates with other levels of the tiers using secured communications. Tiered communications in a tiered embodiment could be in the form of multiple data stores or one data store that maintains a hierarchy of intermediate results. The type of implemented solution may be determined or influenced by the amount of traffic, number and size of stored records, and number of communications between collection points and the data store and the number of information requests from analyst queries. Secured communications may be accomplished using Secure Shell (“SSH”), the Advanced Encryption Standard (“AES”), public key encryption, key encryption, symmetrical key encryption, asymmetrical key encryption, hash-based encryption, and the like.

The data store 310 may store various amounts of data and may use a scalable database: The data store 310 may receive update data from the monitoring device 308 periodically, continuously, on-demand, or in real-time. The monitoring device 308 may push the message to the data store 310 after processing. The monitoring device 308 may utilize SQL to instruct the data store 310 to store data.

In various embodiments of the present disclosure, the monitoring device 308 generates a sufficient amount data to be stored, sent, or managed without comprising the security of LAN 306. The monitoring device 308 may be positioned at a single location, and/or may be implemented in software as a “collection point” where the original source IP and associated data are gathered for storage within the data store 310. The monitoring device 308 may save collected data for a limited time and/or may transmit the data to the data store 310 for storage therein. The data store 310 may destroy data on a predetermined schedule. In some embodiments of the present disclosure, the data store 310 may be implemented in the same hardware as the monitoring device 308 or may be separate therefrom. The data store 310 may be a database, a file system, a magnetic storage medium, an optical storage medium, a SQL database, a relational database, an access database, a table database, an analytical database, a data warehouse, a distributed database, a real-time database, a storage of indexed records, and the like. The data store 310 may use various storage media to store the messages received from the monitoring device 308, such as a hard disk, magnetic storage, a magnetic disk, volatile memory, non-volatile memory, flash memory, an EEPROM, solid-state storage, optical storage, a magneto-optical disc storage, RAM, ROM, dynamic memory, static memory, firmware storage, and the like.

In some embodiments of the present disclosure, the monitoring device 308 may be implemented in software using off-the-shelf hardware, e.g., server hardware, and may be implemented as a low-cost custom network appliance, or as part of a comprehensive Computer Network Defense capability. The monitoring device 308 may also be a dedicated host for the LAN 306, or may be part of a comprehensive computer defense network (“CDN”) capability such as, for example, the Community Data Center.

An alert 314 may be issued to an authorized user about a security threat that was identified using traffic outside of the LAN 306. An authorized user at the analysis point 312 thereafter queries the data store 310 to determine if any internal IP addresses of an IP device within the LAN 306 matches a particular dataflow having particular characteristics corresponding to the alert. The query is forwarded to the data store 310 to examine the saved data for non-source IP elements of the packet. If a match is found from the data collected prior to the NAT translation of the packet-modifying device 302, the original internal source IP of an IP device within LAN 306 can be revealed in response to the query from the analysis point 312. Using this technique, authorized users (i.e., defenders) at the analysis point 312 can resolve enterprise-level flows to end systems behind NAT gateways. That is, an authorized user using the analysis point 312 can determine the IP address of the IP device within the LAN 306 that was identified as a security risk using data monitored outside of the LAN 306. The authorized user can identify the IP address of the IP address despite that the packet-modifying device 302 has modified the data traversing out of the LAN 306, e.g., when communicated to the internet.

Consider the following example illustrated in FIG. 3 that depicts the function of the monitoring device 308 in the LAN 306 where a NAT device within the packet-modifying device 302 changes the source IP from 1.2.3.4 to 128.244.1.2. Prior to NAT packet modification by the packet-modifying device 302, the monitoring device 308 records the destination IP address 1.2.3.4, the destination port value of 80, the source port value of 1025 and the protocol value of 6 when the packets passes from the computer 304 to the monitoring device 308. The monitoring device 308 associates an identifying source IP 192.168.1.105 and adds a timestamp along with a generated record for storage within the data store 310. When a security issue has been identified and an authorized user of the analysis point 312 is alerted, the analysis point 312 receives the alert. The alert includes a source IP address of 128.144.1.2. The authorized user at the analysis point 312 may then attempt to determine the source of the security alert by identifying the LAN IP address of the originating device's original source IP, e.g., the IP address of the computer 304 in this example. The analyst supplies values that are found in the alert—namely, a destination IP address of 1.2.3.4, a destination port of 80, and a protocol value of 6. A request is issued to the data store 310 for an associated original source IP address. The data store 310 searches and returns any and all entries matching the characteristics supplied by the authorized user of the analysis point 312. In the example shown in FIG. 3, a single matching entry was found that returns the original source IP of 192.168.1.105.

Sometimes a query may return multiple possible IP addresses within the LAN 306 that caused the security alert. This condition is referred to as an “overlap” or “collision,” which represents the condition where recorded and/or queried data yields more than one source IP as the origination point within the LAN 306. This occurs when non-unique data is stored from traffic and where multiple hosts communicate with the same destination IP and port, uses the same protocol, and at approximately the same time (e.g., when the timestamps of the alert is compared to the entries within data store 310).

In some embodiments of the present disclosure, more than one monitoring device 308 may be used. For example, there may be one of more of these collection points having a monitoring device 308 throughout the LAN 306 or other network before the packet leaves the protected network such as LAN 306. The analysis point 312 may be part of the LAN 306 or may be outside of and isolated from the LAN 306.

Various kinds of data may be collected from data traversing through the LAN 306 such as full packet capture, a subset of packet fields, and/or a summarization of packet data in IPFIX format or other flow data format. Additionally, there may be one or more packet-permuting devices such as the packet-modifying device 302 that alters the packets from its trip to or from an internal host to the egress point of the protected network. The type of permutations made by a single device or all devices in aggregate determines what fields should be collected by the monitoring device 308 and stored in the data store 310.

The alert used by an authorized user using the analysis point 312 may have various sources of data available ranging from full packet capture, a subset of packet fields, a summarization of packet data (e.g., in IPFIX), an IDS alert (such as from Snort), or some aggregated event from a SIEM (such as from ArcSight) use to determine the source of the security issue within the LAN 306 by querying the data store 310.

In some embodiments, the monitoring device 308 performs full packet capture of data, but only a subset of the captured data is stored within the data store 310 for use by the analysis point 312. Additionally or alternatively, in sonic embodiments, full packet capture may be available for use by the monitoring device 308 but a packet may traverse through additional packet-modifying devices (not shown) in addition to the packet-modifying device 302. Therefore, multiple monitoring devices, e.g., multiple monitoring devices 308, may be strategically positioned within the LAN 306 to collect data to facilitate resolving the obfuscated IP device within the LAN 306.

For example, for each IP device within the LAN 306, a sufficient number of monitoring devices, e.g., monitoring device 308, can be strategically positioned to collect data after knowing and identifying the minimal amount of data field values needed from source to network egress. The monitoring devices 308 then can create a record, identified by the source IP, which contains only those fields sufficient for resolving any obfuscated IP address within the LAN 306. In other words, intermediate packet-modifying devices within the LAN 306 may also include a respective monitoring device to collect data for use within the data store 310. These intermediate monitoring devices may record the source port for later reclamation by a subsequent monitoring device, e.g., the monitoring device 308, or it could omit the source port and record only field values available after network egress for storage within the data store 310. Generally, storing more field values without regard to future availability improves the probability of a unique response from the data store 310 when queried by the analysis point 312.

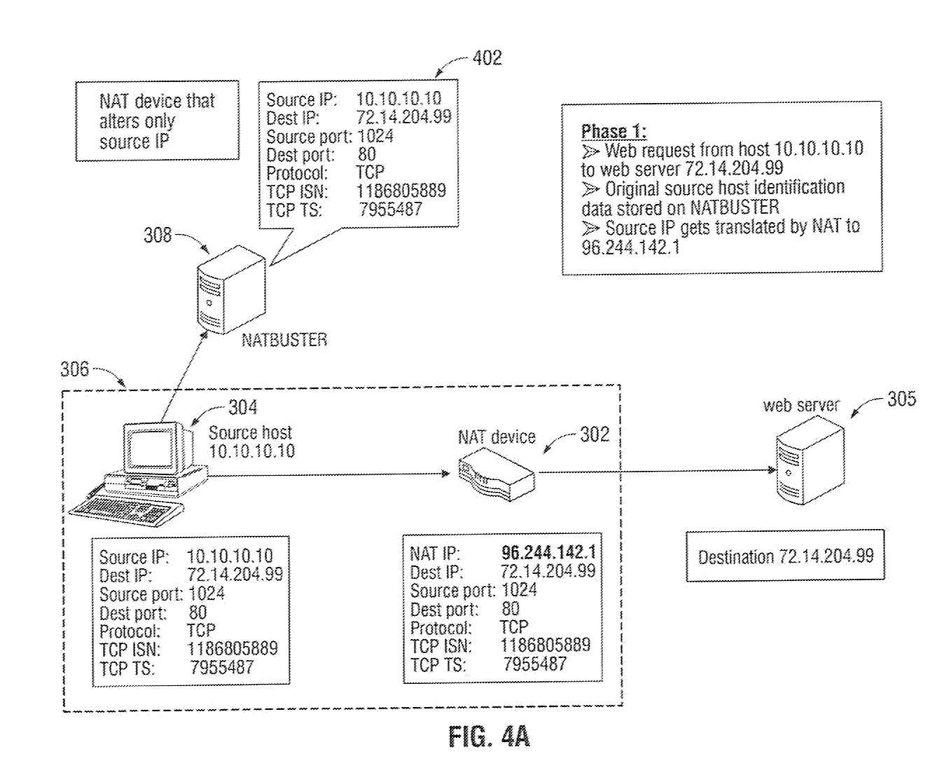

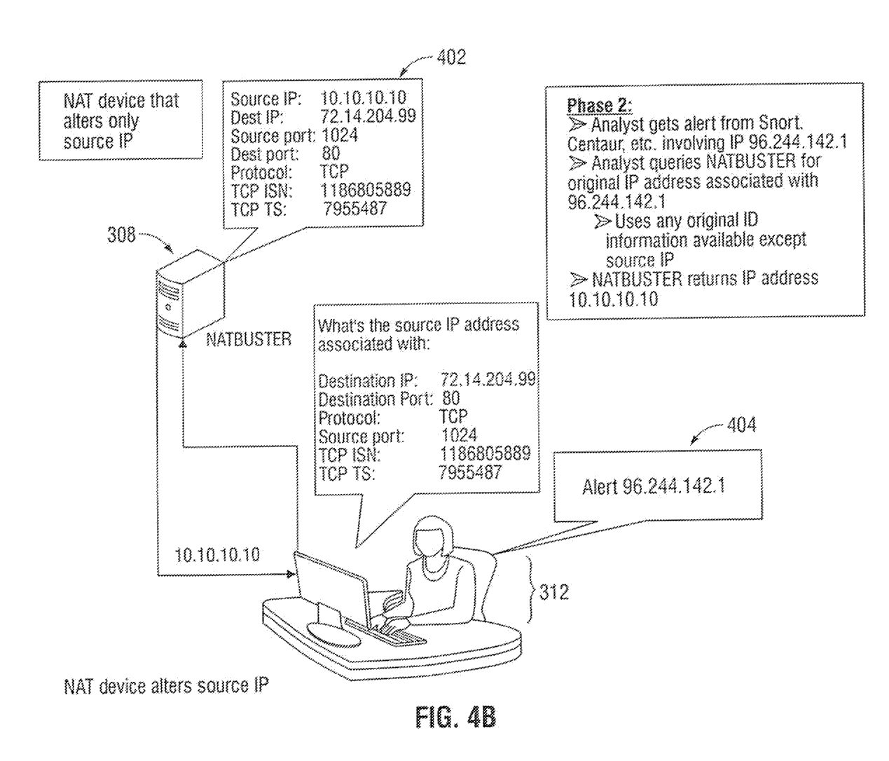

FIGS. 4A and 4B show an illustration of the operation of the monitoring device of FIG. 3 when a packet-modifying device alters the LAN IP address according to the present disclosure. As illustrated in FIG. 4A, only the source IP (i.e., LAN IP) is modified by packet-the modifying device 302. The monitoring device 308 stores the data of the message 402 in the data store 310 of FIG. 3. The computer 304 having a LAN IP address requests a webpage from a server 305 having an internet accessible IP address of 72.14.204.99 (device not shown). The monitoring device 308 records the LAN IP address and the destination IP address. This is the internet accessible IP address of the desired webpage. Upon transmission of the request from the computer 304 to the sever 305, the source IP address of the packets is obfuscated and changed to that of the NAT device 302.

As shown in FIG. 4B, when an alert 404 containing the IP addressed of the NAT device 302 is received, the defender using the analysis point 312 sends an alert 404 to the monitoring device 308 (or in other embodiments, to the data store 310 of FIG. 3) to determine the LAN IP. As shown in FIG. 4B, by comparing the destination address of 72.14.204.99 to other communication data, the address of the computer 304 is determined. That is, the source of the alert 404 is determined to be the computer 304 having an LAN address of 10.10.10.10.

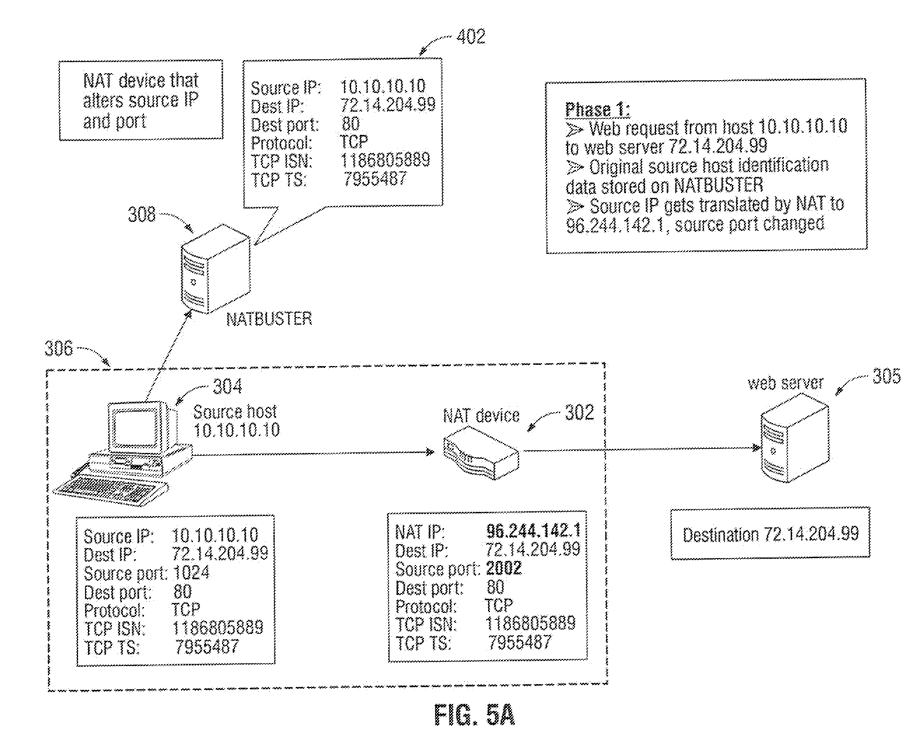

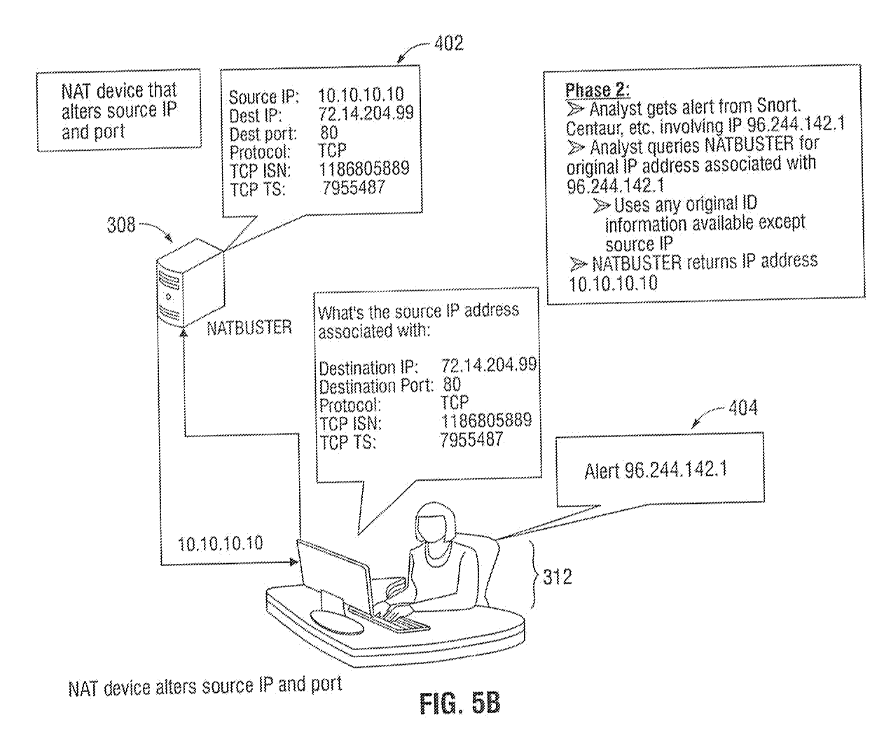

FIGS. 5A and 5B show an illustration of the operation of the monitoring device 302 when the packet-modifying device 302 alters the LAN IP address and a port value according to the present disclosure. As shown in FIG. 5A, the computer 302 has an IP address of 10.10.10.10 and accesses a web server having the IP address of 72.14.204.99. The monitoring device 308 stores the communication data 402. Note that the packet-modifying device 302 in addition to changing the IP address also changes the source port from 1024 of computer 304 to 2002. However, even with this modification, the upon receipt of the alert 404, the analysis point 312 can query the monitoring device 308 to determine the source IP address of 10.10.10.10 by comparing the obfuscated data to the original communication data 402.

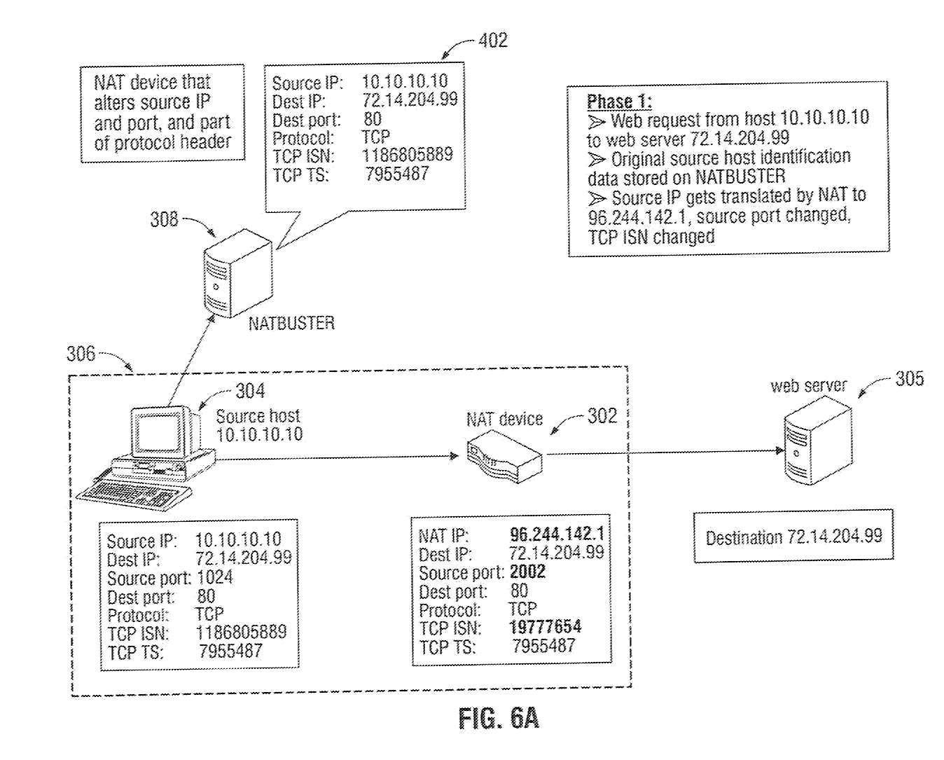

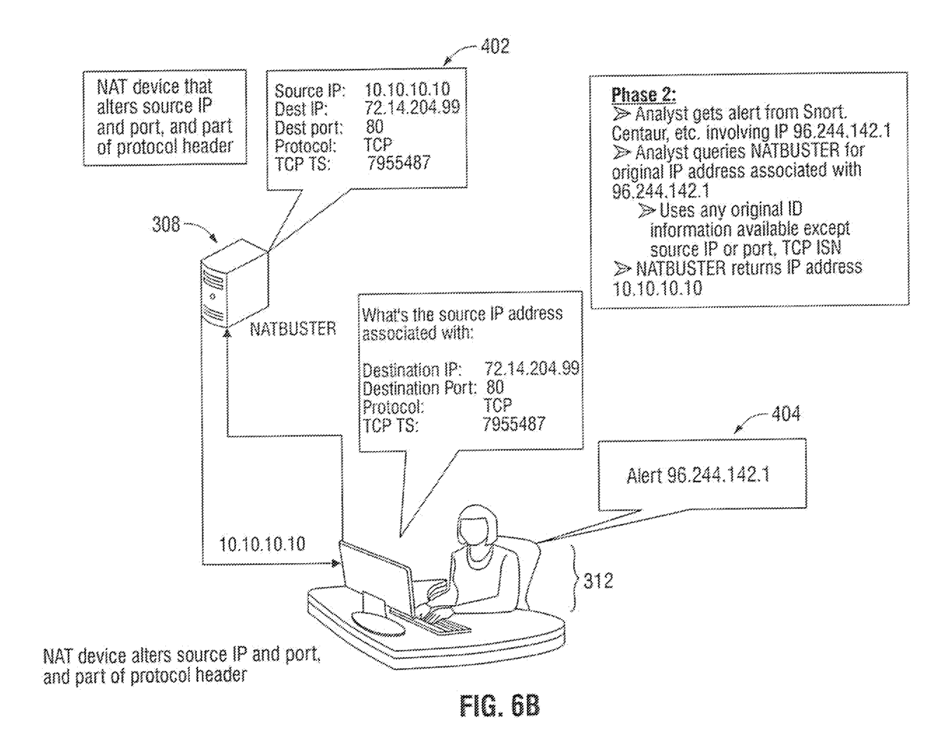

FIGS. 6A and 6B show an illustration of the operation of the monitoring device 308 when the packet-modifying device 302 alters the LAN IP address, a port value, and part of the protocol header. Communications from the computer 304 to the web server with an IP address of 72.14.204.99 through the packet-modifying device 302 which changes the source IP, the source port, and the TCP initial sequence number. The monitoring device 308 may monitor the packets and record the 32-bit initial TCP sequence number as found in the SYN field (e.g., as shown in FIG. 2), or the hash thereof. The 32-bit initial TCP sequence number may be determined during a full packet capture session of the packet-monitoring device 308. The computer generating the alert 404 may determine the 32-bit initial TCP sequence number when full packet capture is available. Additionally or alternatively, the alert 404 may include a full-packet capture session.

The packet-modifying device 302 may include a proxy server that alters part of the protocol header. However, when the alert 404 arrives, the information used to query the monitoring device 308 may be able to determine the source IP address, e.g., the address of the computer 304, to determine the source of the security issue despite the presence of a proxy server by comparing the other communication data recorded or generated by the monitoring device 308.

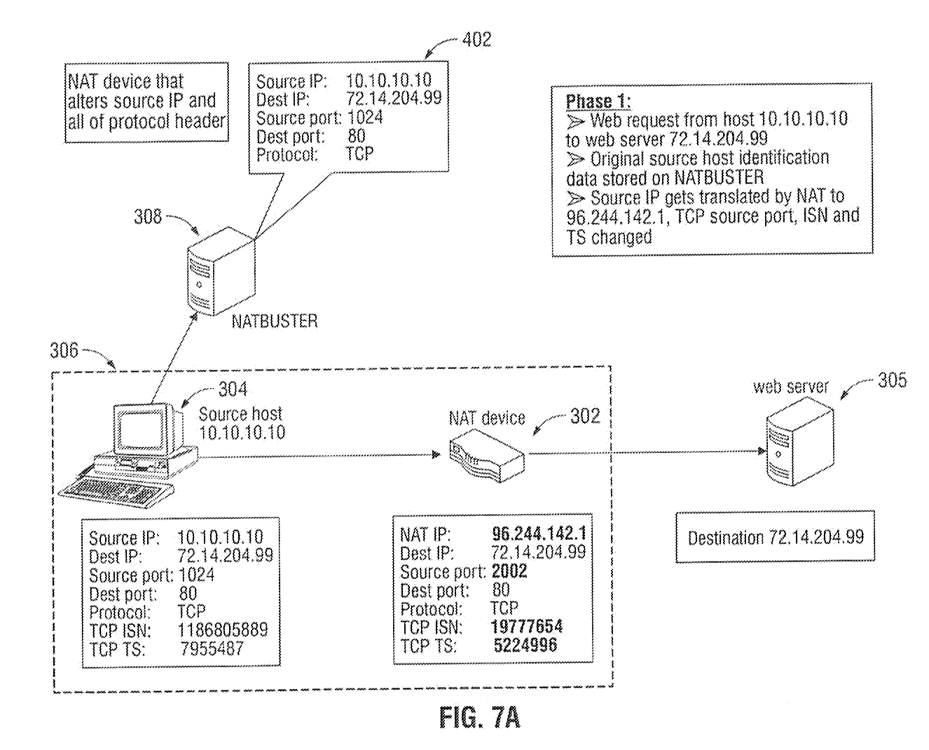

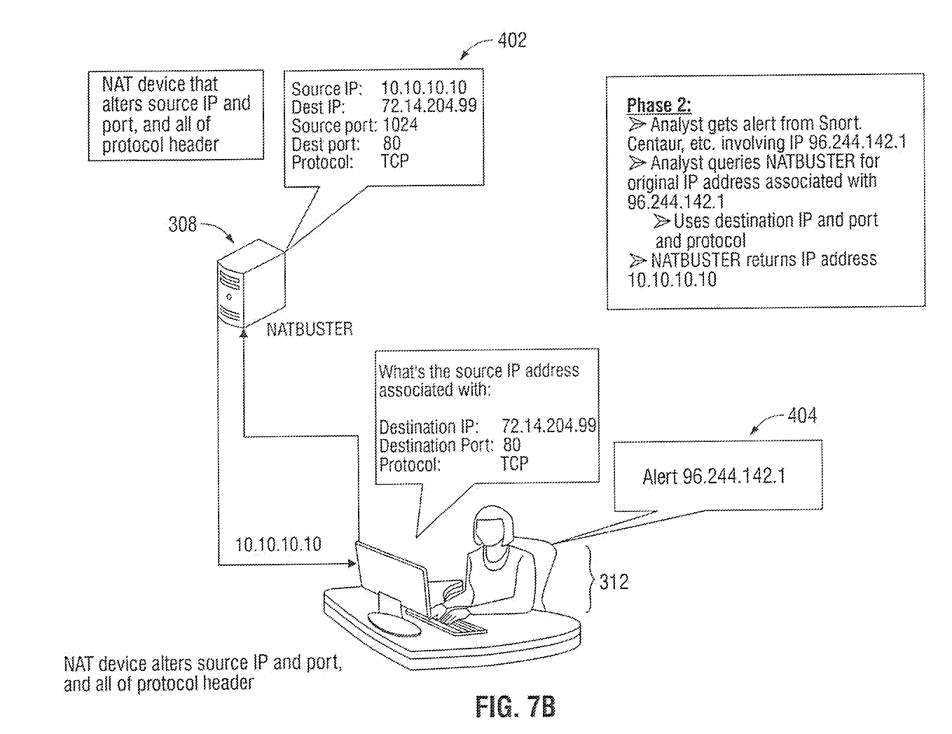

FIGS. 7A and 7B show an illustration of the operation of the monitoring device 308 when the packet-modifying device 302 alters the LAN IP address, the port value, and all of the protocol header. Additionally, a proxy device may alter the header information within packet-modifying device 302 as depicted in FIGS. 7A and 7B. If multiple devices within the LAN 306 access the same destination IP and port simultaneously, overlaps may occur. For example, multiple IP devices within the LAN 306 may match the characteristics exemplified by the alert 404 (as shown in FIGS. 7A and 7B) when there exists multiple instances of malware within the LAN 304 that attempts to communicate to the identical destination host and IP address simultaneously. In this instance, an authorized user at the analysis point 312 needs to know all source IPs associated with the particular destination host. In other words, if sufficient information is collected by the monitoring device 308, the malware infected IP devices may be identified.

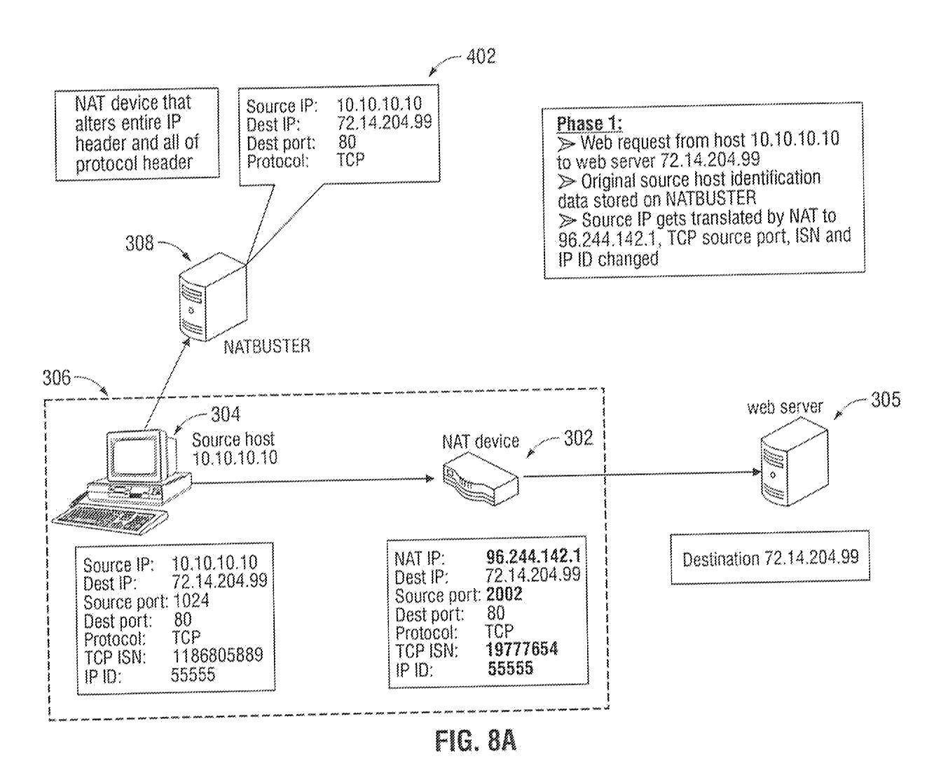

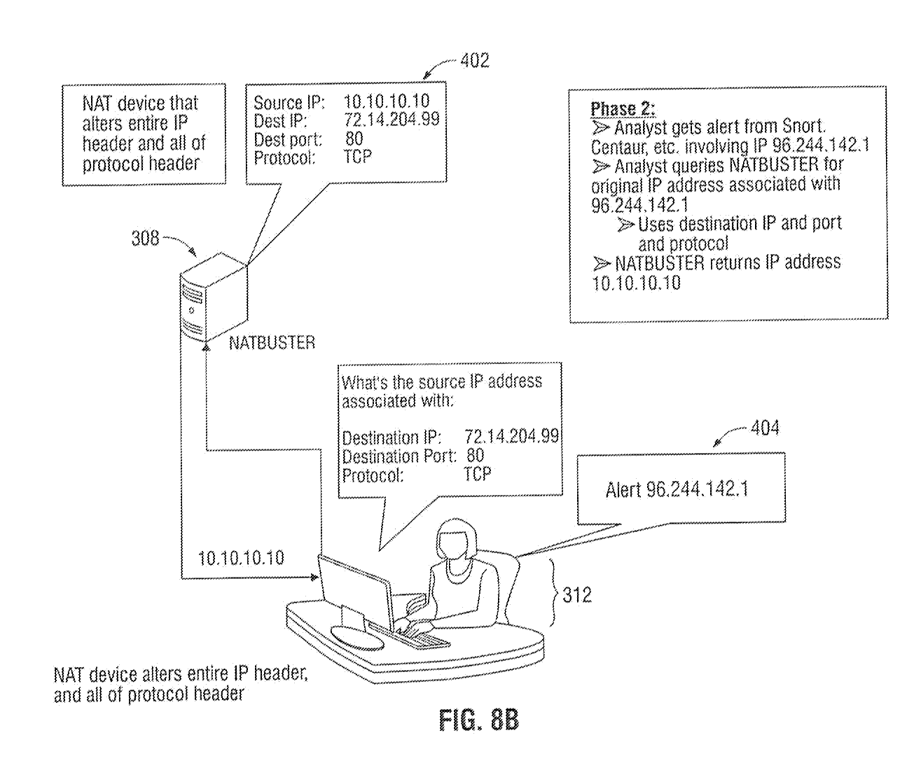

FIGS. 8A and 8B show an illustration of the operation of the monitoring device 208 when the packet-modifying device 302 alters the entire IP header and all of the protocol header. A proxy device within packet-modifying device 302 alters all fields except the destination port and destination IP address. In this case, to identify the origin of a security issue within LAN 306 using TCP communications, it is preferable to include more details in the information about the packets that monitoring device 308 monitors. The additional details are sent from the monitoring device 308 to the data store 310 for store therein. For example, the packet length value may be monitored by the monitoring device 308 for storage within the data store 310.

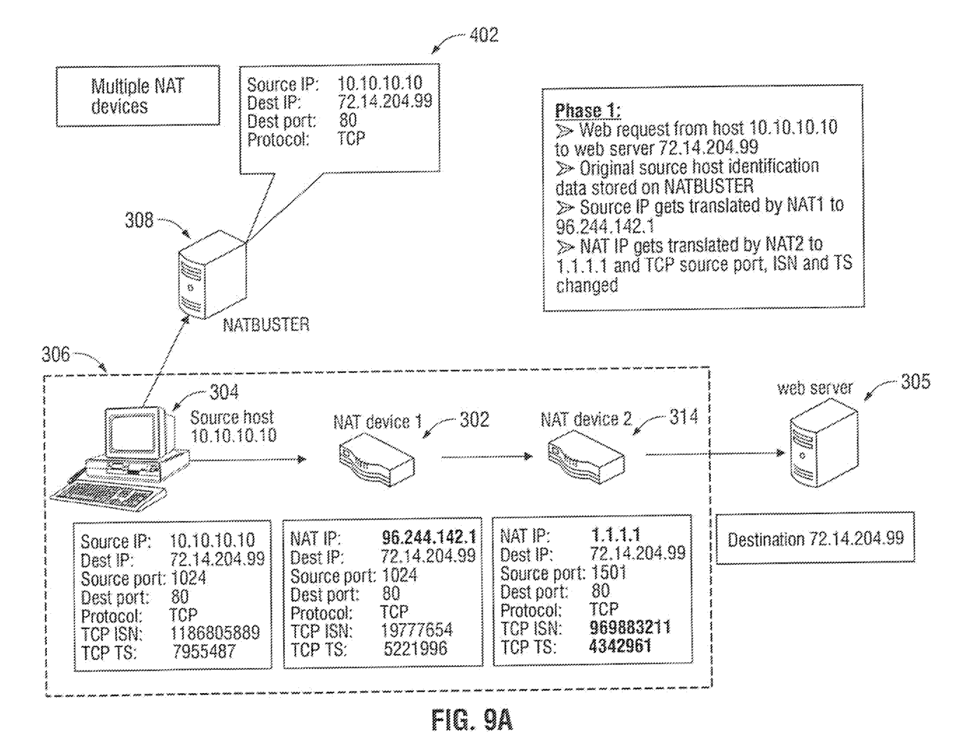

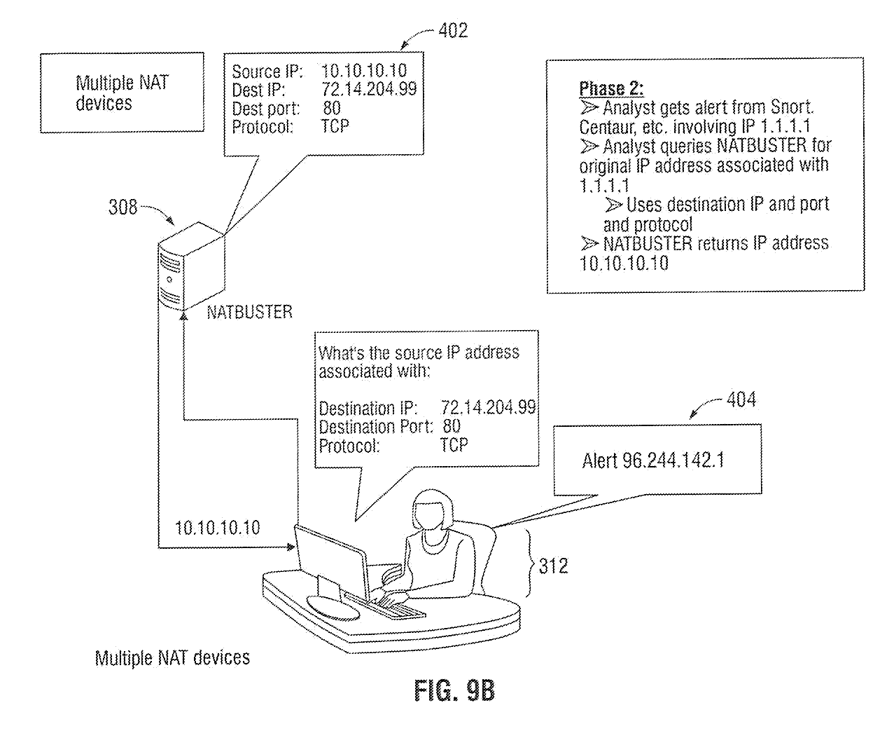

FIGS. 9A and 9B show an illustration of the operation of multiple packet-monitoring devices 302 and 314 as exemplified in FIG. 3 when multiple packet-modifying devices alters the LAN communications according to the present disclosure. Note that a packet from the computer 304 that traverses through both of the packet-modifying devices 302 and 314, may have its header modified multiple times.

In one embodiment, the monitoring device 308 monitors LAN communications before the packet-modifying device 302 modifies the packets to collect field values of the packets that are not altered during travel from the computer 304 to its ultimate destination. For example, a packet that needs to traverse a packet-modifying device 302 acting as a NAT changes only the source IP and the packet-modifying device 314 acting as a proxy server changes the entire protocol header. Therefore, it is preferable to also monitor the packet's traversal between the computer 304 and the packet-modifying device 302. Also it may be desirable for the monitoring device 308 to collect packet information that is not in the protocol header before the packet-modifying device 302. The protocol header will be changed by the packet-modifying devices 302 and 314. Thus, when an alert is obtained, information that was not in the header may be used to identify the security issue within the LAN 304 using information obtained after post-proxy manipulations, i.e., after manipulation by the packet-modifying devices 302 and 314.

In another embodiment, the monitoring device 308 monitors LAN communications before each of the packet-modifying devices 302 and 314. At each collection point, the monitoring device 308 gathers and records a sufficient amount of data including data of the protocol, the destination IP and port (if one exists for the protocol) associated with the LAN IP address of the computer 304, and a timestamp. The analysis of this tiered data must include the ability to perform a recursive search, or some other technique, that links all intermediate data in order to resolve the LAN IP address of the computer 304 using the alert 404. The results should lead to further results all along the various collection points until the original source IP is eventually resolved. For example, the analysis point 312 may use cascading requests to recursive query the data store 310 to receive multiple IP values, each IP value corresponding to a previous hop, until the obfuscated address of the IP device having the security issue is identified. The intermediate results may be viewable by the analysis point 312 as well.

In some embodiments of the present disclosure, TCP may be captured by the monitoring device 308 using full capture data and the SYN traffic may be collected if the source IP is from the protected network. The monitoring device 308 may be within the protected network. The SYN/ACK traffic may be collected if the destination IP belongs to the protected network.

In one embodiment of the present disclosure, the monitoring device 308 monitors TCP traffic using IPFIX (or other flow data format) to provide a single record for each session for recording within the data store 310. The monitoring device 308 can utilize full packet capture to summarize the SYN packet. The monitoring device 308 may store IPFIX data (or other flow data format) in the data store 310 to provide a one-for-one translation of packet data to an IPFIX record or other flow data format. The monitoring device 308 may be adapted to detect aggregate information based on the volume of records for storage within the data store 310.

The data store 310 may periodically purge data. In some embodiments, the data store 310 purges data as a function of the amount of data stored therein. During high traffic conditions, the data store 310 may purge data more often. During low traffic periods, the data store 310 may purge data less often, or not at all. The purging of data by the data store 310 may be scheduled, may be periodic, may be intermittent, may be a function of data, may be tiered, and the like. The data store 310 may also backup data for future use. The backed-up data may be a reduced set of the monitored information and/or may be compressed.

The analysis point 312 may supply the data store 310 during a query the very same values or a subset of the values that were used by the monitoring device 308. The analysis point 312 uses an interface and a secure communications channel to enter all the available data.

A Sourcefire alert may issue the alert to the analysis point 312. An analyst using the analysis point 312 may not have all of the data in the alert and therefore may use an interface and/or a GUI to query the source IP. The interface and/or GUI may be on a different machine than the machine of the analysis point 312 where the analyst may view alerts, data or output from other queries.

After an analyst makes a query using the analysis point 312, the data store 310 (or a program) on the analysis point 312 compares the timestamp values of the message to the values stored in the data store 310. Messages stored within the data store 310 that are within a predetermined range of time triggers one or more positive results. The predetermined range of time corresponds to the timestamp value of a message of interest. That is, the timestamps of the alert and the stored communication data in the data store 310, in some embodiments, are not exactly the same time because a delay exists between the collection of the data by monitoring device 310 and the generation of the alert. The timestamps may be based on a universal time that accounts for time zones, etc. An analyst using the analysis point 312 may modify the data to refine the search for the LAN IP address having the security issue, if necessary, when overlaps are returned.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for identifying a network device, the system comprising:
an external network;
a local area network (“LAN”);
one or more network devices coupled to the LAN, each network device configured for having a network address and to communicate with the LAN;
a packet-modifying device coupled to the LAN and the external network, the packet modifying device having an external-network network address, wherein the packet-modifying device is coupled to the one or more network devices and upon receipt of a communication from a network device of the one or more network devices destined for the external network obfuscates the network address of the network device prior to transmission of the communication to the external network;
a monitoring device operatively coupled to the one or more network devices, the monitoring device monitoring the one or more network devices for generating identifying information of the network device when communicating with the external network via the packet-modifying device, wherein the monitoring device configures the identifying information to identify the obfuscated network address of the network device;
a data store for storing the identifying information; and
an analysis terminal coupled to the data store and adapted to resolve the network address of the network device upon receiving an alert regarding the network address obfuscated by the packet-modifying device.

2. The system according to claim 1, wherein the communication is a data packet.

3. The system according to claim 2, wherein the data packet is an IP packet.

4. The system according to claim 1, wherein the packet-modifying device and the monitoring device are integrated together thereby forming a network appliance.

5. The system according to claim 1, wherein the packet-modifying device is a first network appliance and the monitoring device is a second network appliance, wherein the first and second network appliances are separate from each other.

6. The system according to claim 1, wherein the one or more network devices send a plurality of communications and the monitoring device generates a respective indentifying information for each communication of the plurality of communications to identify a respective network device of the one or more network devices, wherein the data store stores each respective identifying information for each of the plurality of communications.

7. The system according to claim 1, wherein the packet-modifying device obfuscates the network address of the network device by changing the network address of the network device to the external-network network address of the packet-modifying device.

6. The system according to claim I, further comprising a Proxy server for providing a proxy for the one or more network devices to the external network.

7. The system according to claim I, wherein the data store is a database.

8. The system according to claim 1, wherein the packet-modifying device is a Network Address Translator (“NAT”) device.

9. The system according to claim 1, wherein the monitoring device passively monitors the LAN.

10. A monitoring device, comprising:
at least one network interface configured for coupling to a LAN; and
a processing component operatively coupled to the at lease one network interface to monitor communications between a network device within the LAN and an external network, wherein the monitoring device generates identifying information of the network device using the communications, wherein the identifying information is configured for identifying an obfuscated network address of the network device.

11. The device according to claim 10, wherein the processing component communicates the identifying information to a data store using the at least one network interface.

12. The device according to claim 10, wherein the obfuscated network address is obfuscated by a packet-modifying device.

13. The device according to claim 12, wherein the packet-modifying device is at least one of a NAT, a proxy, and a firewall.

14. The device according to claim 10, wherein the monitoring device is a network appliance.

15. The device according to claim 10, wherein the monitoring device passively monitors the communications within the LAN.

16. The device according to claim 10, wherein the monitoring device does not establish communicates with any network devices on the LAN.

17. The device according to claim 10, wherein the communications on the LAN are sent to the monitoring device for forwarding to a packet-modifying device for operative communication with the external network.

18. The device according to claim 10, wherein the processing component generates the identifying information of the communications to includes at least one of a timestamp, a protocol type, a destination IP address, a destination port, a source port, a source Media Access Control (“MAC”) address, a Transmission Control Protocol (“TCP”) Initial Sequence Number (ISN), a packet length, a Internet Protocol Flow Information Export (“IPFIX”) total packets value, a flow data format, and a IPFIX total bytes of the communications.

19. The device according to claim 10, wherein the processing component generates the identifying information of the communications to includes at least one of a version, a header length, a differentiated service, a total length, an identification, a flag, a fragment offset, a time to live, a header checksum, an acknowledgement number, a data offset, a reserved space, a window size, a checksum, a total bytes/packets from IPFIXs, a total number of bytes/packets exchanged in a session, a MAC address-to-physical host pairing, an initial TCP sequence number, a hash value of the initial TCP sequence number, and an urgent pointer of the communications.

20. The device according to claim 10, wherein the indentifying information is from an IPFIX packet.

21. The device according to claim 10, wherein the identifying information is in an IPFIX packet format.

22. The device according to claim 10, wherein the processing component utilizes at least one of a Yet Another Flowmeter (“YAF”) and a library of packet capture (“libpcap”) to determine an Initial Sequence Number (“ISN”) of the communications.

23. An analysis terminal, comprising:
a network interface configured for coupling to a monitoring device; and
a processing component operatively coupled to the network interface to query the monitoring device for identifying information, wherein the indentifying information is configured to identify a network device using communications between the network device within a LAN and an external network, wherein the query is configured to query the monitoring device for identifying the network device using an obfuscated network address of the network device in accordance with an alert including the obfuscated network address.

24. The analysis terminal according to claim 23, wherein the communications on the LAN are sent to the monitoring device for forwarding to a packet-modifying device for operative communication with the external network.

25. The analysis terminal according to claim 23, wherein the monitoring device responds to the query with the identifying information including at least one of a timestamp, a protocol type, a destination IP address, a destination port, a source port, a source Media Access Control (“MAC”) address, a Transmission Control Protocol (“TCP”) Initial Sequence Number (ISN), a packet length, a Internet Protocol Flow Information Export (“IPFIX”) total packets value, and a IPFIX total bytes of the communications.

26. The analysis terminal according to claim 23, wherein the monitoring device responds to the query with the identifying information including at least one of a version, a header length, a differentiated service, a total length, an identification, a flag, a fragment offset, a time to live, a header checksum, an acknowledgement number, a data offset, a reserved space, a window size, a checksum, a total bytes/packets from IPFIXs, a total number of bytes/packets exchanged in a session, a MAC address-to-physical host pairing, an initial TCP sequence number, a hash value of the initial TCP sequence number, and an urgent pointer of the communications.

27. The analysis terminal according to claim 23, wherein the indentifying information is from an IPFIX packet.

28. The analysis terminal according to claim 23, wherein the identifying information is in an IPFIX packet format.

29. The analysis terminal according to claim 23, wherein the monitoring device is at least one of a Yet Another Flowmeter (“YAF”) and a library of packet capture (“libpcap”) to determine an Initial Sequence Number (“ISN”) of the communications.

30. The analysis terminal according to claim 23, wherein the obfuscated network address is obfuscated by a packet-modifying device.
